(19) United States
(12) Patent Application Publication
(10) Pub. No.: US 2025/0211078 A1
(43) Pub. Date: Jun. 26, 2025

(54) METHOD TO CONTROL E-MOTOR RESIN TRANSFER MOLDING PROCESS

(71) Applicant: Ford Global Technologies, LLC, Dearborn, MI (US)

(72) Inventors: Youji Ma, Troy, MI (US); Bryce Andrew Schwager, Ypsilanti, MI (US)

(73) Assignee: Ford Global Technologies, LLC, Dearborn, MI (US)

(21) Appl. No.: 18/390,792

(22) Filed: Dec. 20, 2023

(51) Int. Cl. H02K 15/12; H02K 15/02

(52) U.S. Cl. CPC H02K 15/12; H02K 15/02; H02K 2215/00

(57) ABSTRACT

A method of transfer molding a rotor core stack includes assembling a mandrel and a runner plate between a clamp press and a plunger, determining a final clamp press position, a nominal clamp press position, and a nominal plunger position, calculating a height offset, and calculating a normalized position of the plunger. The plunger moves at a first speed until the plunger contacts a liquid polymer within a reservoir located between the runner plate and the plunger. The plunger moves at a second speed until the plunger reaches the normalized position to extrude the liquid polymer in the reservoir through the runner plate and into the rotor core stack. The plunger speed is controlled to maintain a constant pressure between the plunger and the liquid polymer until the liquid polymer transfer finishes and the plunger stops at a final plunger position.

### FIELD

The present disclosure relates to a method of transfer molding rotor cores for electric traction motors.

### BACKGROUND

The statements in this section merely provide background information related to the present disclosure and may not constitute prior art.

Electric traction motors are used to provide propulsion in electric vehicles and hybrid electric vehicles. Electric traction motors traditionally include a stationary component, or stator, and a rotating component, or rotor. The rotor includes a rotor core stack and magnets that are inserted into cavities of the rotor core stack. The magnets are sealed in the rotor core stack with thermosetting resin in a resin transfer molding press process.

During the resin transfer molding process a press clamps a rotor core stack between a mandrel and a runner plate via the bottom of the press and the top of the press. Raw resin is placed in a reservoir located above the runner plate and is heated to a liquid state. A plunger moves at a set speed and presses the liquid state resin through the runner plate to fill a majority of the cavities around the magnets in the rotor core stack. Once the plunger reaches a predetermined position the plunger moves at a variable speed to maintain a set pressure to fill the remaining cavities in the rotor core stack with the liquid resin for a set period of time. The plunger then strops and remains in the final position so the liquid resin can cure. Once the resin is cured to a solid state, the magnets are permanently sealed within the rotor core stack.

The point at which the plunger switches from moving at a constant speed to a variable speed directly affects the quality of the rotor core stack. If the switch happens too early the liquid resin may not completely fill all of the cavities in the rotor core stack. If the switch happens too late the pressure may spike resulting in the liquid resin being extruded from the rotor core stack. Having a fixed position for the plunger to switch from moving at a constant speed to a variable speed does not take variations between the volumes of the rotor core stack cavities into account. As such, the switch may occur too early for some rotor core stacks and too late for others resulting in increased quality concerns in the transfer molding process.

The present disclosure addresses challenges related to molding process variations in electric motor rotor stacks.

### SUMMARY

This section provides a general summary of the disclosure and is not a comprehensive disclosure of its full scope or all of its features.

In one form of the present disclosure, a method of polymer transfer molding a rotor core includes: assembling the rotor core stack between a mandrel and a runner plate which is between a clamp press and a plunger; determining a final clamp press position of the clamp press, a nominal clamp press position of the clamp press, and a nominal plunger position; calculating a height offset; calculating a normalized position of the plunger by adding the nominal plunger position and the height offset; moving a plunger at a first speed until the plunger reaches an initial position; adjusting the speed of the plunger to a second speed until the plunger reaches the normalized position, wherein the plunger extrudes a liquid polymer in a reservoir located between the runner plate and the plunger through the runner plate and into the rotor core stack; and controlling the speed of the plunger to maintain a constant pressure between the plunger and the liquid polymer until the liquid polymer transfer finishes and the plunger stops at a final plunger position.

In variations of this method, which may be implemented individually or in combination: calculating the height offset of the rotor core stack further includes calculating a difference between the final clamp press position and the nominal clamp press position of the clamp press to determine a position difference; calculating the height offset of the rotor core stack further includes normalizing a plunger cross-sectional area of a bore of the plunger by a cross-sectional area of the rotor core stack to determine a normalized area; the cross-sectional area of the rotor core stack is a cross-sectional area of a plurality of cavities of the rotor core stack; the final clamp press position of the clamp press is a distance between a top surface of a clamp press and a top surface of the runner plate located on a top surface of the rotor core stack; the nominal plunger position is a distance between a bottom surface of the plunger and a top surface of the runner plate located on a top surface of the rotor core stack; determining the nominal clamp press position of the clamp press further includes adding the height of the rotor core stack, the height of the mandrel, and the height of the runner plate; determining the nominal plunger position further includes averaging a plurality of final plunger positions from a data set; the nominal plunger position is a predetermined distance above the averaged final plunger position; and retaining the plunger in the final plunger position for a specified time for the liquid polymer to cure.

In another form, a method of polymer transfer molding a rotor core stack includes: assembling the rotor core stack between a mandrel and a runner plate which is between a clamp press and a plunger; determining a final clamp press position of the clamp press, a nominal clamp press position of the clamp press, and a nominal plunger position of the plunger; calculating a difference between the final clamp press position and the nominal clamp press position of the clamp press to determine a position difference; normalizing a plunger cross-sectional area of a bore of the plunger by a cross-sectional area of plurality of cavities of the rotor core stack to determine a normalized area; calculating a height offset by multiplying the normalized area and the position difference; calculating a normalized position of the plunger by adding the nominal plunger position and the height offset; moving a plunger at a first speed until the plunger reaches an initial position; adjusting the speed of the plunger to a second speed until the plunger reaches the normalized position, wherein the plunger extrudes a liquid polymer in a reservoir located between the runner plate and the plunger through the runner plate and into the rotor core stack; controlling the speed of the plunger to maintain a constant pressure between the plunger and the liquid polymer until the liquid polymer transfer finishes and the plunger stops at a final plunger position; and retaining the plunger in the final plunger position for a specified time for the liquid polymer to cure.

In variations of this method, which may be implemented individually or in combination: the final clamp press position of the clamp press is a distance between a top surface of a clamp press and a top surface of the runner plate located on a top surface of the rotor core stack; the nominal plunger position is a distance between a bottom surface of the plunger and a top surface of the runner plate located on a top surface of the rotor core stack; determining the nominal clamp press position further includes adding the height of the rotor core stack, the height of the mandrel, and the height of the runner plate; determining the nominal plunger position further includes averaging a plurality of final plunger positions from a data set; and the nominal plunger position is a predetermined distance above the averaged final plunger position.

In yet another form of the present disclosure, a system of polymer transfer molding a rotor core stack includes: a rotor core stack; a clamp press disposed beneath a bottom surface of the rotor core stack; a runner plate disposed above a top surface of the rotor core stack; a plunger disposed above the runner plate; at least one sensor to determine a final clamp press position of the clamp press and a final plunger position of the plunger; and a controller to determine a nominal clamp press position and nominal plunger position, calculate a height offset of the rotor core stack, and calculate a normalized position of the plunger by adding the nominal plunger position and the height offset, wherein the controller controls a movement of the plunger.

In variations of this system, which may be implemented individually or in combination: the height offset is a position difference multiplied by a normalized area, wherein the position difference is a difference between the final clamp press position and the nominal clamp press position of the clamp press, and wherein the normalized area is a cross-sectional area of the rotor core stack divided by a plunger cross-sectional area of a bore of the plunger; the cross-sectional area of the rotor core stack is a cross-sectional area of a plurality of cavities of the rotor core stack; and the nominal plunger position is an average of a plurality of final plunger positions from a sample data set offset by a predetermined distance.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 depicts a schematic view of a rotor core stack in a transfer molding press according to the present disclosure;

FIG. 2 depicts a puck of the rotor core stack according to the present disclosure;

FIG. 3A depicts a schematic view of a nominal clamp press position and a nominal plunger position of a rotor core stack in a transfer molding press according to the present disclosure;

FIG. 3B depicts a schematic view of a normalized plunger position of a rotor core stack in a transfer molding press according to the present disclosure;

FIG. 3C depicts a schematic view of a final clamp press position and a final plunger position of a rotor core stack in a transfer molding press according to the present disclosure;

FIG. 4 depicts a method of transfer molding a rotor core stack; and

FIG. 5 depicts a method to calculate a height offset of a core stack of the rotor core according to FIG. 3.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

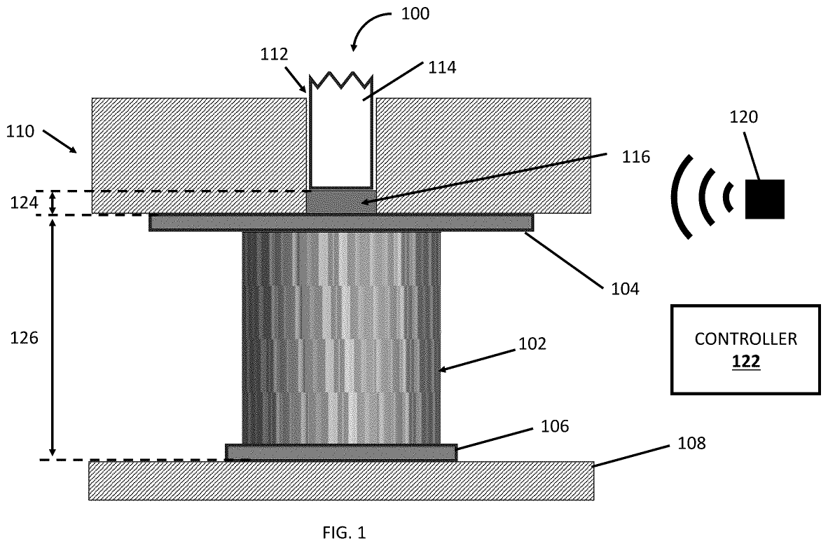

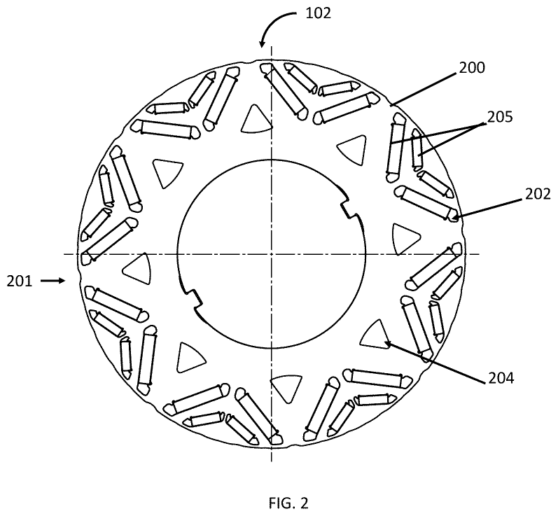

Referring to FIGS. 1 and 2, a transfer molding system 100 includes a rotor core stack 102. The rotor core stack 102 includes a series of rotor core 200 stacked on top one another along a vertical direction. The rotor core stack 102 further includes a plurality of cavities 201 disposed within each of the rotor core 200 of the rotor core stack 102. The cavities 201 include a plurality of magnet slots 202 where a plurality of magnets 205 are disposed. In one form, the cavities 201 of the rotor core stack 102 may also include structural apertures 204.

The transfer molding system 100 further includes a runner plate 104, a mandrel 106, a clamp press 108 and a support member 110. The rotor core stack 102 is disposed between the runner plate 104 and the mandrel 106. The mandrel 106 is disposed on a top surface of the clamp press 108 and the rotor core stack 102 is disposed on a top surface of the mandrel 106. The runner plate is then disposed above the rotor core stack 102 and below the support member 110. During the transfer molding press process, the clamp press 108 moves toward the support member 110 to clamp the rotor core stack 102 between the runner plate 104 and the mandrel 106 with a pre-determined force.

The transfer molding system 100 further includes a plunger 114 disposed within an aperture of the support member 110. The aperture and runner plate 104 define a reservoir 112. The reservoir 112 is located between the runner plate 104 and the plunger 114. A solid polymer is placed within the reservoir 112 and heated until it reaches the liquid state and becomes a liquid polymer 116. In one form, the liquid polymer 116 is an epoxy resin.

During the transfer molding press process the plunger 114 presses the liquid polymer 116 through apertures in the runner plate 104 to fill cavities within the rotor core stack 102. The liquid polymer 116 fills the space between the plurality of magnet slots 202 and the plurality of magnets 205. Once the liquid polymer 116 cures and reaches a solid state, the plurality of magnets 205 are permanently retained within the plurality of magnet slots 202. In one form, the cavities may also include structural apertures 204 that are filled with the liquid polymer 116 to provide structural support to the rotor core stack 102 once the liquid polymer 116 cures.

The transfer molding system 100 further includes at least one sensor 120 and a controller 122. The at least one sensor 120 determines a clamp press position 126 of the clamp press 108 and a plunger position 124 of the plunger 114. The clamp press position 126 provides the location of the clamp press in relation to the rest of the transfer molding system 100. In one form, the clamp press position 126 is the distance between a top surface of the clamp press 108 and a top surface of the runner plate 104. In various forms, the clamp press position 126 is when the clamp press 108 is in the final position that clamps that mandrel 106, the rotor core stack 102, and the runner plate 104 between the clamp press 108 and the support member 110 with a predetermined force. The plunger position 124 provides the location of the plunger in relation to the rest of the transfer molding system 100. In a particular form, the plunger position 124 is a distance between the bottom surface of the plunger 114 and the top surface of the runner plate 104. In one form, the plunger position 124 is when the plunger 114 is in the final position and has finished extruding the liquid polymer 116 into the rotor core stack 102. The sensor 120 conveys the clamp press position 126 and the plunger position 124 to the controller 122.

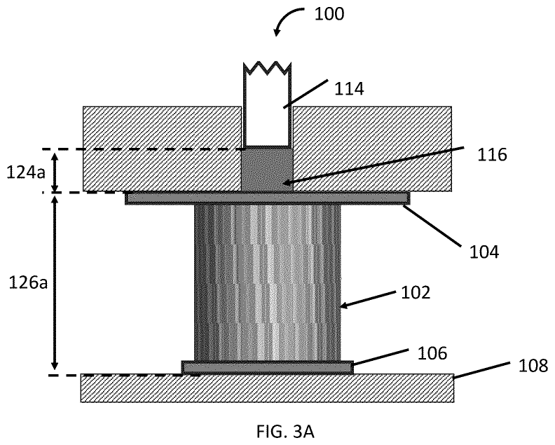

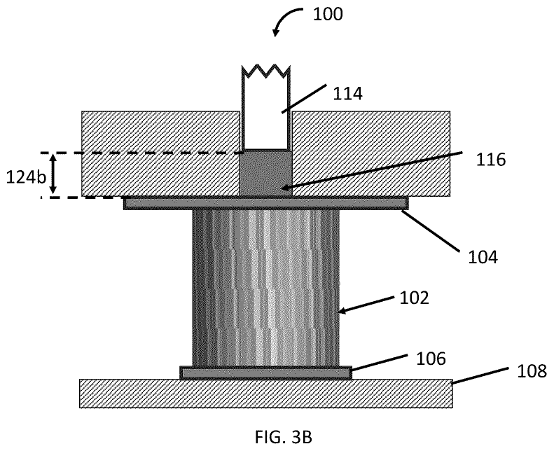

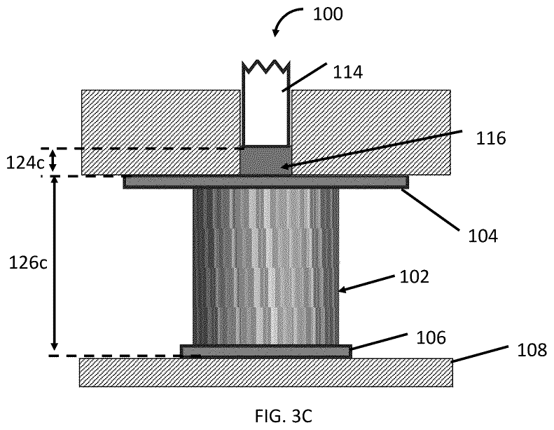

Referring to FIG. 3A, the clamp press position 126 includes a nominal clamp press position 126a. In one form, the nominal clamp press position 126a is the summation of the height of the rotor core stack 102, the runner plate 104, and the mandrel 106. In another form, the nominal clamp press position 126a may be an average or mean of a plurality of final positions of the clamp press 108 from a sample data set of previous rotor core stack 102 transfer molding systems 100.

The plunger position 124 includes a nominal plunger position 124a. The nominal plunger position 124a is determined by averaging a plurality of final positions of the plunger 114 from a sample data set of previous rotor core transfer molding assemblies. In one form the nominal plunger position 124a is offset from the averaged final position by a predetermined value. In one form, the nominal plunger position 124a is between one and three millimeters above the average of the plurality of final positions of the plunger 114. In one form, the nominal plunger position 124a is two millimeters above the average of the plurality of final plunger positions of the plunger 114.

Referring to FIG. 3B, the plunger position 124 includes a normalized plunger position 124a. The normalized plunger position 124b of the plunger 114 is calculated by adding the nominal plunger position 124a and a height offset.

Referring to FIG. 3C, the clamp press position 126 includes a final clamp press position The final clamp press position 126c is when the clamp press 108 is in the final position that clamps the mandrel 106, the rotor core stack 102, and the runner plate 104 between the clamp press 108 and the support member 110 with a predetermined force. In one form, the final clamp press position 126c is the nominal clamp press position 126a. In other forms, the final clamp press position 126c may vary from the nominal clamp press position 126a by a tolerance within a predetermined tolerance range.

The plunger position 124 includes a final plunger position 124c, as shown in FIG. 3C. The final plunger position 124c is when the plunger 114 is in the final position and has finished extruding the liquid polymer 116 into the rotor core stack 102. In one form, the final plunger position 124c is variable and is determined based on the transfer molding process for each rotor core stack 102. During the final phase of the transfer molding process, the plunger 114 extrudes the liquid polymer 116 through apertures in the runner plate 104 with a predetermined pressure for a first predetermined duration of time. The plunger 114 is then stopped and held for a second predetermined duration of time while the liquid polymer 116 cures into a solid. In one form, the position at which the plunger 114 is stopped is the final plunger position 124c.

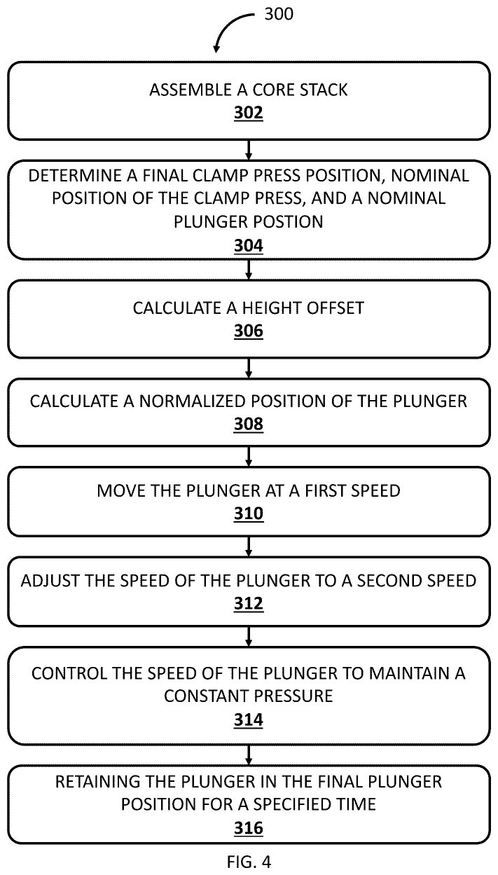

Referring to FIG. 4, a method 300 of transfer molding a rotor core stack is shown. In step 302, a rotor core stack 102 is assembled between the mandrel 106 and the runner plate 104 which is between the clamp press 108 and plunger 114. In one form, the mandrel 106 is disposed on a top surface of the clamp press 108 and the rotor core stack 102 is disposed on a top surface of the mandrel 106. The runner plate is then disposed above the rotor core stack 102 and below the support member 110 and plunger 114.

In step 304 the at least one sensor 120 determines the final clamp press position 126c. The controller 122 records the final clamp press position 126c and determines a nominal clamp press position 126a of the clamp press 108 and a nominal plunger position 124a of the plunger 114. In one form, determining the nominal clamp press position 126a includes adding the height of the rotor core stack 102, the runner plate 104, and the mandrel 106. In another form, determining the nominal clamp press position 126a determining an average or a mean of a plurality of final positions of the clamp press 108 from a sample data set of previous rotor core stack 102 transfer molding systems 100. In one form, the nominal clamp press position 126a is the final clamp press position 126c of the clamp press 108. Determining the nominal plunger position 124a includes averaging a plurality of final plunger positions of the plunger 114 from a sample data set of previous rotor core transfer molding assemblies. The nominal plunger position 124a is between one and three millimeters above the average of the plurality of final plunger positions of the plunger 114. In one form, the nominal plunger position 124a is two millimeters above the average of the plurality of final plunger positions of the plunger 114.

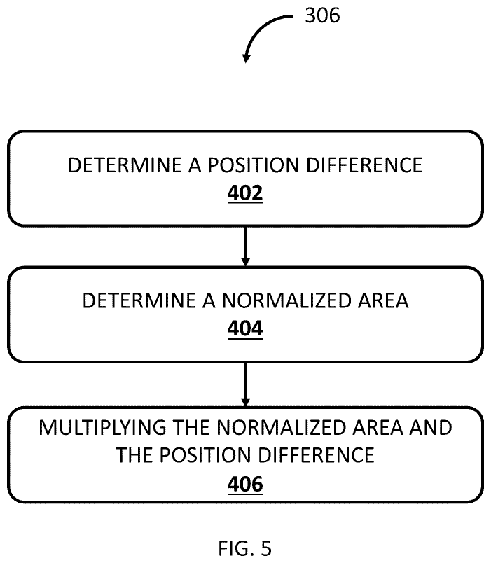

In step 306, the controller 122 calculates a height offset. Referring to FIG. 5, further details of step 306 are provided. In step 402 a position difference is determined by subtracting the nominal clamp press position 124a from the final clamp press position 126c. The controller then determines a normalized area in step 404. The normalized area is the cross-sectional area of the rotor core stack 102 divided by the cross-sectional area of the bore of the plunger 114. In one form the cross-sectional area of the rotor core stack 102 is the total cross-sectional area of the cavities 201 of the rotor core stack 102. In one form, the total cross-sectional area of the cavities 201 includes at least one of the total cross-sectional area of the plurality of magnet slots 202 and the total cross-sectional area of the structural apertures 204. In step 406 the normalized area of step 404 is multiplied with the position difference of step 402 to provide the height offset of the rotor core stack 102. The height offset is determined by the below equation:

$$Height Offset = \frac{{A}_{2}}{{A}_{1}} ( {X}_{2} - \overline{{X}_{2}} )$$

Where X₂ is the final clamp press position 126c, X̅₂ is the nominal clamp press position 126a, A₁ is the cross-sectional area of the bore of the plunger 114, and A₂ is the cross-sectional area of the rotor core stack 102.

In step 308 a normalized plunger position 124b of the plunger 114 is calculated. The normalized plunger position 124b is the summation of the nominal plunger position 124a and the height offset calculated in step 306. The normalized plunger position 124b is dependent on the geometry of the rotor core stack 102 as it takes the height and cross-sectional area of the cavities 201 of the rotor core stack 102 into account. Step 308 may be completed before, after, or concurrently with step 310.

In step 310 the controller 122 controls the movement of the plunger 114. The plunger 114 is moved at a first speed until the plunger 114 reaches an initial position. In one form, the initial position is just before the plunger 114 contacts the liquid polymer 116 within the reservoir 112. In another form the initial position is the position in which the plunger 114 first contacts the liquid polymer 116 within the reservoir 112. In yet another form, the initial position may be a predetermined position of the plunger 114. In one form the first speed is constant but may be varied in other forms. The speed of the plunger 114 is then adjusted to a second speed in step 312. The second speed is a constant speed. In one form, the second speed is less than the first speed. In another form the second speed is the same as the first speed. As the plunger 114 moves at the second speed, the liquid polymer 116 in the reservoir 112 is extruded through apertures in the runner plate 104 into the cavities 201 of the rotor core stack 102. The plunger 114 is moved at the second speed until the plunger 114 reaches the normalized plunger position 126b. In one form, once the plunger 114 reaches the normalized plunger position 124b a majority of the volume of the cavities 201 are filled with the liquid polymer 116. In one form, a majority of the volume of cavities 201 being filled is between 90 to 95 percent of the volume of cavities 201 being filled with the liquid polymer 116.

Once the plunger 114 reaches the normalized plunger position 124b the speed of the plunger 114 is controlled to maintain a constant pressure between the plunger 114 and the liquid polymer 116 in step 314. In one form, the speed of the plunger may be varied to maintain the constant pressure. In one form, the constant pressure is set at a value between 10 to 50 bar. The point at which the plunger 114 switches from moving at a constant speed to maintaining a constant pressure affects the quality of the rotor core stack. If the switch happens too early the liquid polymer 116 may not completely fill all of the cavities 201 in the rotor core stack 102. If the switch happens too late, the pressure may spike resulting in the liquid polymer 116 being extruded from the rotor core stack 102. As the plunger 114 moves while maintaining the constant pressure, the liquid polymer 116 in the reservoir 112 continues to be extruded through the apertures in the runner plate 104 into the cavities 201 of the rotor core stack 102. The plunger 114 moves while maintaining the constant pressure until the liquid polymer 116 transfer finishes and the plunger 114 stops at the final plunger position 124c. The final plunger position 124c may vary between each rotor core stack 102.

In step 316 the plunger 114 is retained in the final plunger position 124c for a specified time while the liquid polymer 116 cures. The specified time for the liquid polymer 116 to cure is dependent on the chemical structure of the liquid polymer 116. In one form, the specified time may be between 60 to 240 seconds. Once the liquid polymer 116 is cured to the solid state, the magnets 205 are permanently sealed within the rotor core stack.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of transfer molding a rotor core stack, the method comprising:
assembling the rotor core stack between a mandrel and a runner plate which is between a clamp press and a plunger;
determining a final clamp press position of the clamp press, a nominal clamp press position of the clamp press, and a nominal plunger position;
calculating a height offset;
calculating a normalized position of the plunger by adding the nominal plunger position and the height offset;
moving a plunger at a first speed until the plunger reaches an initial position;
adjusting the speed of the plunger to a second speed until the plunger reaches the normalized position, wherein the plunger extrudes a liquid polymer within a reservoir located between the runner plate and the plunger through the runner plate and into the rotor core stack; and
controlling the speed of the plunger to maintain a constant pressure between the plunger and the liquid polymer until the plunger stops at a final plunger position.

2. The method of claim 1, wherein calculating the height offset of the rotor core stack further comprises calculating a difference between the final clamp press position and the nominal clamp press position of the clamp press to determine a position difference.

3. The method of claim 2, wherein calculating the height offset of the rotor core stack further comprises normalizing a plunger cross-sectional area of a bore of the plunger by a cross-sectional area of the rotor core stack to determine a normalized area.

4. The method of claim 3, wherein the cross-sectional area of the rotor core stack is a cross-sectional area of a plurality of cavities of the rotor core stack.

5. The method of claim 1, wherein the final clamp press position of the clamp press is a distance between a top surface of a clamp press and a top surface of the runner plate located on a top surface of the rotor core stack.

6. The method of claim 1, wherein the nominal plunger position is a distance between a bottom surface of the plunger and a top surface of the runner plate located on a top surface of the rotor core stack.

7. The method of claim 1, wherein the determining the nominal clamp press position of the clamp press further comprises adding the height of the rotor core stack, the height of the mandrel, and the height of the runner plate.

8. The method of claim 1, wherein the determining the nominal plunger position further comprises averaging a plurality of final plunger positions from a data set.

9. The method of claim 8, wherein the nominal plunger position is a predetermined distance above the averaged final plunger position.

10. The method of claim 1, further comprising retaining the plunger in the final plunger position for a specified time for the liquid polymer to cure.

11. A method of transfer molding a rotor core stack, the method comprising:
assembling the rotor core stack between a mandrel and a runner plate which is between a clamp press and a plunger;
determining a final clamp press position of the clamp press, a nominal clamp press position of the clamp press, and a nominal plunger position of the plunger;
calculating a difference between the final clamp press position and the nominal clamp press position of the clamp press to determine a position difference;
normalizing a plunger cross-sectional area of a bore of the plunger by a cross-sectional area of plurality of cavities of the rotor core stack to determine a normalized area;
calculating a height offset by multiplying the normalized area and the position difference;
calculating a normalized position of the plunger by adding the nominal plunger position and the height offset;
moving a plunger at a first speed until the plunger reaches an initial position;
adjusting the speed of the plunger to a second speed until the plunger reaches the normalized position, wherein the plunger extrudes a liquid polymer within a reservoir located between the runner plate and the plunger through the runner plate and into the rotor core stack;
controlling the speed of the plunger to maintain a constant pressure between the plunger and the liquid polymer until the plunger stops at a final plunger position; and
retaining the plunger in the final plunger position for a specified time for the liquid polymer to cure.

12. The method of claim 11, wherein the final clamp press position of the clamp press is a distance between a top surface of a clamp press and a top surface of the runner plate located on a top surface of the rotor core stack.

13. The method of claim 11, wherein the nominal plunger position is a distance between a bottom surface of the plunger and a top surface of the runner plate located on a top surface of the rotor core stack.

14. The method of claim 11, wherein the determining the nominal clamp press position further comprises adding the height of the rotor core stack, the height of the mandrel, and the height of the runner plate.

15. The method of claim 11, wherein the determining the nominal plunger position further comprises averaging a plurality of final plunger positions from a data set.

16. The method of claim 15, wherein the nominal plunger position is a predetermined distance above the averaged final plunger position.

17. A system of transfer molding a rotor core stack, the system comprising:
a rotor core stack;
a clamp press disposed beneath a bottom surface of the rotor core stack;
a runner plate disposed above a top surface of the rotor core stack;
a plunger disposed above the runner plate;
at least one sensor to determine a final clamp press position of the clamp press and a final plunger position of the plunger; and
a controller to determine a nominal clamp press position and nominal plunger position, calculate a height offset of the rotor core stack, and calculate a normalized position of the plunger by adding the nominal plunger position and the height offset,
wherein the controller controls a movement of the plunger.

18. The system of claim 17, wherein the height offset is a position difference multiplied by a normalized area, wherein the position difference is a difference between the final clamp press position and the nominal clamp press position of the clamp press, and wherein the normalized area is a cross-sectional area of the rotor core stack divided by a plunger cross-sectional area of a bore of the plunger.

19. The system of claim 18, wherein the cross-sectional area of the rotor core stack is a cross-sectional area of a plurality of cavities of the rotor core stack.

20. The system of claim 17, wherein the nominal plunger position is an average of a plurality of final plunger positions from a sample data set offset by a predetermined distance.
